(19) United States
(12) Patent Application Publication
(10) Pub. No.: US 2010/0250983 A1
(43) Pub. Date: Sep. 30, 2010

(54) POWER SAVING CONTROL SYSTEM

(75) Inventor: DAO-WEI WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD, Shenzhen City (CN); HON HAI PRECISION INDUSTRY CO., LTD., Tu-Cheng (TW)

(21) Appl. No.: 12/430,135

(22) Filed: Apr. 27, 2009

(30) Foreign Application Priority Data
Mar. 30, 2009 (CN) 200910301228.3

(51) Int. Cl. G06F 1/32; G06F 9/445

(52) U.S. Cl. 713/320; 713/2

(57) ABSTRACT

A power saving control system includes a power supply, a voltage conversion unit, an electrical switch, a control chip having a general programmable input output (GPIO) pin and a basic input system (BIOS) chip. The power supply is configured for supplying a voltage. The voltage conversion unit is connected to the power supply to receive the voltage and configured for converting the voltage into a working voltage of an electronic element, and outputting the working voltage. The electrical switch is connected between the voltage conversion unit and an input terminal of the electronic element. The control chip is connected to the electrical switch. The BIOS chip is connected to the control chip to control the electrical switch to be turned on or off via controlling an output value of the GPIO pin of the control chip to control the electrical element to work.

### BACKGROUND

1. Technical Field

The present disclosure relates to control systems, and particularly to a control system that can save power.

2. Description of Related Art

With the development of motherboards, the motherboards have more and more functions. The number of functional chips on motherboards is increasing, therefore more and more power is being consumed. Sometimes some of the functional chips are not used, but still consume power, which is undesirable.

### BRIEF DESCRIPTION OF THE DRAWINGS

FIG. 1 is a block diagram of an exemplary embodiment of a power saving control system.

FIG. 2 is a circuit diagram of an exemplary embodiment of the power saving control system of FIG. 1.

### DETAILED DESCRIPTION

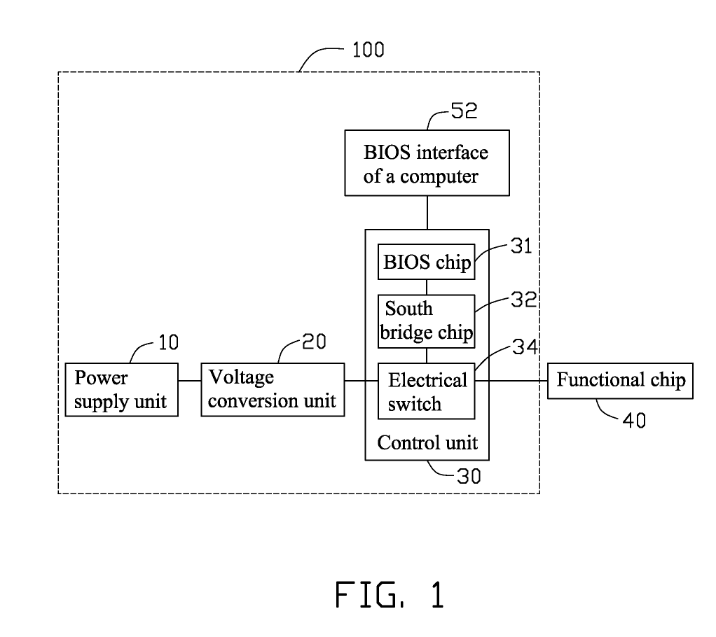

Referring to FIG. 1, an exemplary power saving control system 100 is configured for selectively controlling power to an electronic element such as a functional chip 40 to save power when the chip 40 is not needed. The power saving control system 100 includes a power supply unit 10, a voltage conversion unit 20, a control unit 30, and a basic input output system (BIOS) interface 52 of a computer. The power supply unit 10 is connected to the voltage conversion unit 20 to supply a voltage to the voltage conversion unit 20. The voltage conversion unit 20 is configured for converting the voltage supplied by the power supply unit 10 into a working voltage of the functional chip 40 and outputting the working voltage. The control unit 30 is connected between the voltage conversion unit 20 and the functional chip 40 to determine whether the functional chip 40 should receive the working voltage output by the voltage conversion unit 20, thereby controlling the functional chip 40 to work.

The control unit 30 includes a BIOS chip 31, a south bridge chip 32 as a control chip, and an electrical switch 34. The south bridge chip 32 is connected between the BIOS chip 31 and the electrical switch 34 to control the electrical switch 34 to be turned on or off. The BIOS interface 52 of the computer corresponds to the BIOS chip 31.

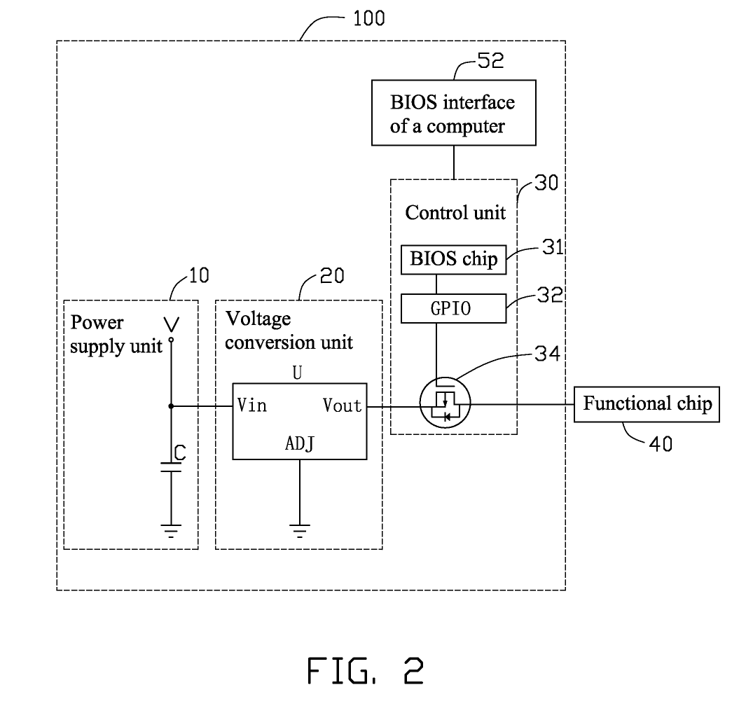

Referring to FIG. 2, the power supply unit 10 includes a voltage source V and a capacitor C. The voltage conversion unit 20 is a voltage conversion chip U. The voltage conversion chip U includes an input pin Vin, an adjusting pin ADJ, and an output pin Vout. The input pin Vin of the voltage conversion chip U is connected to the voltage source V of the power supply unit 10, and grounded via the capacitor C. The adjusting pin ADJ of the voltage conversion chip U is grounded. The output pin Vout of the voltage conversion chip U is connected to a first terminal of the electrical switch 34. A second terminal of the electrical switch 34 is connected to a voltage input terminal of the functional chip 40. A third terminal of the electrical switch 34 is connected to a general programmable input output (GPIO) pin of the south bridge chip 32. The BIOS chip 31 is set to control output of the GPIO pin through the BIOS interface 52 of a computer. An output value of the GPIO pin is set to high level to save energy when the functional chip 40 is not needed, or set to low level when the functional chip 40 is needed, to turn off or on the electrical switch 34, which determines whether the functional chip 40 should receive the work voltage output by the voltage conversion chip U.

In one embodiment, the electrical switch 34 is P-type field-effect transistor (FET). The first terminal of the electrical switch 34 is the source of the FET. The second terminal of the electrical switch 34 is the drain of the FET. The third terminal of the electrical switch 34 is the gate of the FET. In this embodiment the voltage conversion chip U is an FET model FAN1589DX. The functional chip 40 is a display card whose model number is ATI RN50 on a motherboard. The display card has four working voltages, which are 3.3V, 2.5V, 1.8V, and 1.2V. The display card working at the 1.2V is taken as an example to describe the power saving control system 100. According to a standard of the display card, the greatest current consumption of the display card is 1.5 A when the display card works at 1.2V The maximum load current of the FET FAN1589DX is 2.4 A, which is greater than 1.5 A, therefore, an FET FAN1589DX can be used as the electrical switch 34 as well. In other embodiments, the electrical switch 34 and voltage conversion unit can be some other kind of FET or similar p art, but has to have a load current standard greater or equal to a greatest current consumption of the functional chip 40. The south bridge chip 32 can instead be a super input/output chip.

When it is desired to have the functional chip 40 available to work, the output value of the GPIO pin is set to low level through the BIOS interface 52. The computer is restarted after saving the output value. The BIOS chip 31 controls the GPIO pin to output the low level signal to the third terminal of the electrical switch 34. The electrical switch 34 is turned on. The functional chip 40 is capable of receiving the work voltage output by the voltage conversion chip U. The functional chip 40 is capable of working.

When the functional chip 40 is not needed, the output value of the GPIO pin is set to high level through the BIOS interface 52. The computer is restarted after saving the output value. The BIOS chip 31 controls the GPIO pin to output the high level signal to the third terminal of the electrical switch 34. The electrical switch 34 is turned off. The functional chip 40 cannot receive the working voltage from the voltage conversion chip U, and stops working.

In other embodiments, the output value of the GPIO pin can be set to some other value according to the type of the electrical switch 34 to control the electrical switch 34 to turn on when the functional chip 40 is needed to work, and turn off to when the functional chip 40 is not needed to work.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A power saving control system for selectively controlling power to an electronic element of a computer to save power when not needed, the power saving system comprising:
a power supply configured for supplying a voltage;
a voltage conversion unit connected to the power supply to receive the voltage supplied by the power supply and configured for converting the voltage into a working voltage of the electronic element, and outputting the working voltage;
an electrical switch connected between the voltage conversion unit and a voltage input terminal of the electronic element;
a control chip having a general programmable input output (GPIO) pin connected to the electrical switch; and
a basic input output system (BIOS) chip connected to the control chip to control the electrical switch to be turned on or off via controlling an output value of the GPIO pin of the control chip, which determines whether the electronic element should receive the working voltage output by the voltage conversion unit, to control the electrical element to work.

2. The power saving control system of claim 1, wherein the control chip is a south bridge chip or a super input/output chip.

3. The power saving control system of claim 1, wherein the electrical switch is a P-typed field-effect transistor (FET), the gate of the FET is connected to the GPIO pin of the control chip, the source of the FET is connected to the voltage conversion unit, the drain of the FET is connected to the voltage input terminal of the electronic element.

4. The power saving control system of claim 3, wherein the power supply unit comprises a voltage source, the voltage conversion unit is a voltage conversion chip, the voltage conversion chip comprises an input pin, an adjusting pin and an output pin, the input pin of the voltage conversion chip is connected to the voltage source of the power supply, the adjusting pin is grounded, the output pin of the voltage conversion chip is connected to the source of the FET.

5. The power saving control system of claim 1, wherein the electronic element is a functional chip.

6. The power saving control system of claim 5, wherein the functional chip is a display card.

7. The power saving control system of claim 1, wherein the BIOS chip controls the GPIO pin to outputs a low level signals or a high level signal via setting the BIOS chip through a BIOS interface of the computer, an output value of the GPIO pin is set to high level to save energy when the chip is not needed, or set to low level when the chip is needed, to turn off or on the electrical switch.

8. A method of a power saving control system for controlling an electronic element to work, comprising:
providing a power supply for supplying a voltage;
providing a voltage conversion unit for receiving the voltage supplied by the power supply and converting the voltage into a working voltage of the electronic element, and outputting the working voltage;
providing an electrical switch for connecting the voltage conversion and a voltage input terminal of the electronic element;
providing a control chip having a general programmable input output (GPIO) pin for connecting to the electrical switch;
providing a basic input output system (BIOS) chip for connecting to the control chip;
setting the BIOS chip through a BIOS interface of a computer and setting an output value of the GPIO pin;
saving the output value set in the BIOS interface and restarting the computer;
controlling the GPIO pin to output a signal corresponding to the set output value to turn on or off the electrical switch; and
receiving the working voltage output by the voltage conversion unit via the electrical switch in response to the electrical switch is turned on, failing to receiving the working voltage output by the voltage conversion unit owing to the electrical switch is turned off.

9. The method of claim 8, wherein the control chip is a south bridge chip or a super input/output chip.

10. The method of claim 8, wherein the electrical switch is a P-typed field-effect transistor (FET), a gate of the FET is connected to the GPIO pin of the control chip, a source of the FET is connected to the voltage conversion unit, a drain of the FET is connected to a voltage input terminal of the electronic element.

11. The method of claim 10, wherein the power supply unit comprises a voltage source, the voltage conversion unit is a voltage conversion chip, the voltage conversion chip comprises an input pin, an adjusting pin and an output pin, the input pin of the voltage conversion chip is connected to the voltage source of the power supply, the adjusting pin is grounded, the output pin of the voltage conversion chip is connected to the source of the FET.

12. The method of claim 8, wherein the electronic element is a functional chip.

13. The method of claim 8, wherein the functional chip is a display card.

14. The method of claim 8, wherein the output value of the GPIO pin is set to high level to save energy when the electronic element is not needed, or set to low level when the electronic element is needed, to turn off or on the electrical switch.

15. The method of claim 8, wherein the electronic element is capable of working in response to receiving the working voltage output by the voltage conversion unit, the electronic element stops working in response to not receiving the working voltage output by the voltage conversion unit.
